(19) United States
(12) Patent Application Publication
(10) Pub. No.: US 2006/0255179 A1
(43) Pub. Date: Nov. 16, 2006

(54) Novelty fluid display device and method of operation

(76) Inventor: Chu-Yuan Liao, Taipei (TW)

Correspondence Address: LAMORTE & ASSOCIATES P.C., P.O. BOX 434, YARDLEY, PA, 19067, US

(21) Appl. No.: 11/126,986

(22) Filed: May 12, 2005

(51) Int. Cl. A62C 13/62; A62C 13/66; A62C 35/58

(52) U.S. Cl. 239/302; 239/303; 239/304

(57) ABSTRACT

A fluid display device and method of formation. A fluid chamber is provided that has at least one transparent section. The fluid chamber is filled with two fluids of different densities, wherein a heavy fluid fills said fluid chamber to a first level and a light fluid fills the fluid chamber from the first level to a second level. A fountain structure is provided within the fluid chamber. The fountain structure is connected to a pump. Heavy fluid from below the first level is drawn by the pump and pumped through the fountain structure to a point above the first level. As a consequence, heavy fluid is drawn by the pump and is expelled from the fountain structure into the lighter fluid.

### BACKGROUND OF THE INVENTION

1. Field of the Invention

The present invention relates to novelty fluid displays that contain dissimilar fluids. More particularly, the present invention relates to fluid displays that contain fluids having different densities so that the fluids settle at different levels within the display.

2. Background Art

In the field of toys and novelty items, there are many fluid display devices that contain dissimilar fluids. The fluids contained within the fluid display device are mutually insoluble. As such, the two fluids remain separate when confined within a common container. Furthermore, fluids of different densities are used. In this manner, not only do the fluids remain separate, they settle at different levels within the fluid display device.

One of the most popular of the fluid display devices is the wave machine. In a traditional wave machine, two fluids are used to fill an elongated rectangular tube. The elongated rectangular tube is then slowly rocked back and forth. The fluids inside the tube flow across one another and produce waveforms that are interesting to observe.

In the present invention, a new fluid display device is provided for dissimilar fluids. The fluids are retained in a globe. A fountain structure is provided within the globe that circulates the fluids. The display device, therefore, provides an all-fluid version of a traditional snow globe that is highly interesting to observe. The present invention fluid display device is described and claimed below.

### SUMMARY OF THE INVENTION

The present invention is a fluid display device and method of formation. A fluid chamber is provided that has at least one transparent section. The fluid chamber is filled with two fluids of different densities, wherein a heavy fluid fills said fluid chamber to a first level and a light fluid fills the fluid chamber from the first level to a second level. A fountain structure is provided within the fluid chamber. The fountain structure is connected to a pump. Heavy fluid from below the first level is drawn by the pump and pumped through the fountain structure to a point above the first level. As a consequence, heavy fluid is drawn by the pump and is expelled from the fountain structure into the lighter fluid. The result is a fountain within the fluid chamber where the heavy fluid creates a flow pattern that is interesting to observe.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a side view of an exemplary embodiment of the present invention fluid display device;

FIG. 2 is a side view of the exemplary embodiment of FIG. 1 with the pump in operation; and

FIG. 3 is a side view of the exemplary embodiment of FIG. 1 shown with the pump in operation and with the fill composition being agitated.

### DETAILED DESCRIPTION OF THE DRAWINGS

Although the present invention can have many shapes, such as that of a small fish bowl or a gum ball dispenser, the present invention is particularly well suited to be shaped as a snow globe. Accordingly, the present invention fluid display device will be described as configured as a snow globe in order to set forth the best mode contemplated for the invention. However, it will be understood that other shape configurations can be used and the present invention fluid display device is not limited to a snow globe shape.

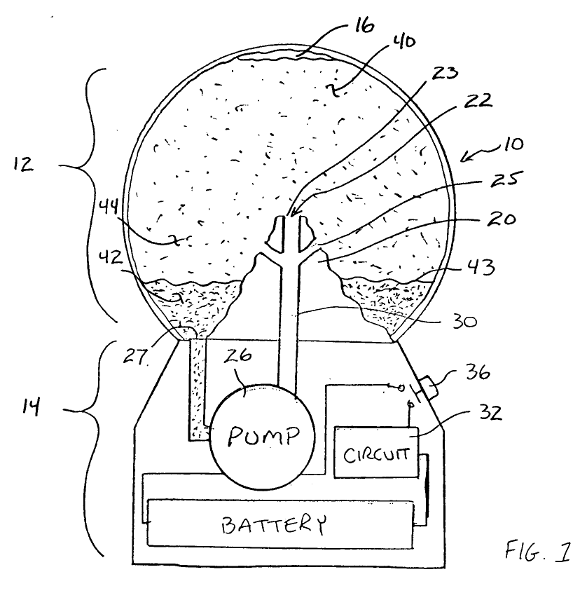

Referring to FIG. 1, there is an exemplary embodiment of a fluid display device 10. The fluid display device 10 has a transparent section 12 that is supported upon an opaque base 14. The transparent section 12 is mostly hollow and defines a fluid chamber 16. In the shown embodiment, the transparent section 12 is spherical in shape. However, the shape is merely exemplary and other non-round shapes can be used.

A fountain protrusion 20 extends upwardly from the base 14 and passes into the fluid chamber 16 that is defined by the transparent section 12. The fountain protrusion 20 can have many shapes. In the shown embodiment, the fountain protrusion 20 has the shape of a volcano. However, the shape of the fountain protrusion 20 is a matter of design choice. As such, the fountain protrusion 20 can be ornamental and can have the shape of a globe, an animal, the Eiffel tower, or any other object.

The fountain protrusion 20 contains at least one exit port 22, and preferably a plurality of exits ports. In the shown embodiment, the fountain protrusion 20 has one top exit port 23 and a plurality of side angled exit ports 25 that are symmetrically disposed around the fountain protrusion 20.

A pump 26 is located in the base 14 of the fluid display device 10. The pump 26 has an intake port 27 that communicates with the bottom of the fluid chamber 16. The pump 26 also has an output port 28 that is attached to a conduit 30. The conduit 30 passes through the fountain protrusion 20 and terminates with the exits ports 22 on the fountain protrusion 20. As such, it will be understood that when the pump 26 is activated, the pump 26 draws fluid from the bottom of the fluid chamber 16 and pumps that fluid up through the fountain protrusion 20 and out of the exit ports 22 of the fountain protrusion 20.

The pump 26 is coupled to a control circuit 32 and batteries 34. An activation button 36 is present on the control circuit 32. When the activation button 36 is depressed, the control circuit 32 activates the pump 26 for a predetermined period of time. Once that period of time elapses, the control circuit 32 automatically deactivates the pump 26. The preferred period of time for activation is between ten seconds and thirty seconds. However, longer periods of time can be used.

The fluid chamber 16 of the fluid display device 10 is filled with a liquid fill Gomposition 40. The liquid fill composition 40 is comprised of at least two fluids 42, 44. The fluids 42, 44 selected are not intersoluable. Thus, the fluids 42, 44 remain separate and distinct within the liquid fill composition 40. Furthermore, the two fluids 42, 44 selected have different densities. Thus, the heavier fluid 42 will settle at the bottom of the fluid chamber 12, while the lighter fluid 44 floats to the top. It is also preferred that the two fluids 42, 44 have dissimilar colors so that the two fluids 42, 44 can be easily visually distinguished.

Since the two fluids 42, 44 have different densities, it will be understood that the heavier fluid 42 fills the fluid chamber 16 from the bottom of the fluid chamber 16 up to a first level 43. The second lighter fluid 44 floats atop the heavier fluid 42 and fills the fluid chamber 16 from the first level 43 to the top of the fluid chamber 16. The fountain protrusion 20 extends upwardly in the fluid chamber 16. Although the bottom of the fountain protrusion 20 extends through the heavy fluid 42, the exit ports 22 are supported in the lighter fluid 44 above the first level 43.

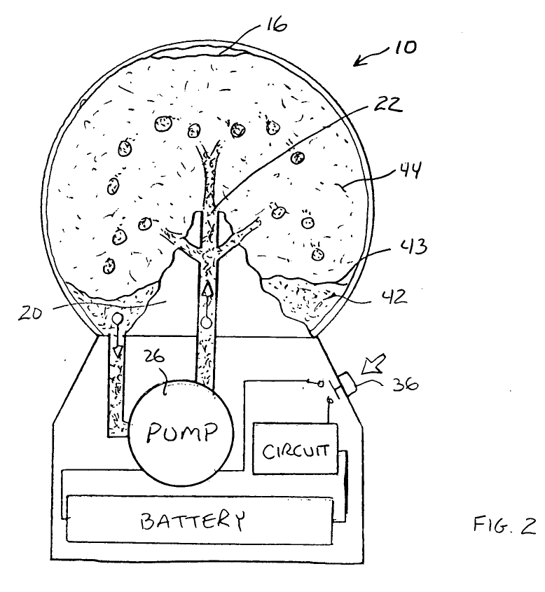

Referring to FIG. 2, it can be seen that once the activation button 36 is pushed and the pump 26 is activated, the pump 26 draws the liquid fill composition 40 from the bottom of the fluid chamber 16 and expels that fluid out of the exits ports 22 of the fountain protrusion 20. Since the heavier fluid 42 lay at the bottom of the fluid chamber 16, this heavier fluid 42 is first drawn and pumped by the pump 26. As the heavier fluid 42 is pumped out of the exit ports 22 of the fountain protrusion 20, the heavier fluid 42 is expelled into the body of the second lighter fluid 44. The expelled heavier fluid 42 therefore falls through the second lighter fluid 44 back to the bottom of the fluid chamber 16. The falling droplets of heavier fluid 42 creates a fountain flow pattern that projects away from the exits ports 22 on the fountain protrusion 20. If the fluid display device 10 is stationary, the flowing heavier fluid 42 will fall in a parabolic trajectory toward the bottom of the fluid chamber 16.

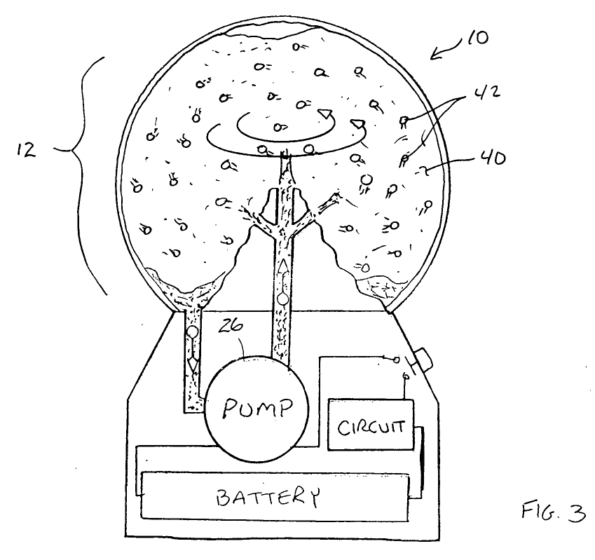

However, the entire fluid display device 10 can be lifted and agitated while the pump 26 is activated. Since the transparent section 12 of the fluid display device 10 is spherical, a circular motion can readily be created in the liquid fill composition 40 by rotating the fluid display device 10. Referring to FIG. 3, it can be seen that if the pump 26 is activated while the liquid fill composition 40 is swirling, the droplets of heavier fluid 42 will orbit the fountain protrusion 20 as they fall toward the bottom of the fluid chamber 16. The result is a swirl of droplets that cause the fluid display device 10 to resemble the snow whirl of a traditional snow globe.

It will be understood that the embodiment of the present invention fluid display device that is shown is merely exemplary and that a person skilled in the art can make many variations to the shown embodiment by substituting equivalent components. For instance, the transparent section and base of the fluid display device can have many shapes. Similarly, the fountain protrusion can have many shapes. Many different fluids can also be used in the creation of the liquid fill composition. However, it is desired that the liquid fill composition be non-toxic. Accordingly, various vegetable oils and water can be used. All such variations, modifications and alternate embodiments are intended to be included within the scope of the present invention as defined by the claims.

What is claimed is:

1. A fluid display device, comprising:
a fluid chamber that defines an interior, wherein said fluid chamber has a bottom, a top, and at least one transparent section that enables said interior to be viewed;
a first fluid of a first density contained within said fluid chamber in a volume sufficient to partially fill a first portion of said fluid chamber from said bottom to a first level;
a second fluid having a second density lower than that of said first fluid, that fills a second portion of said fluid chamber from said first level to said top;
a fountain protrusion disposed within said interior of said fluid chamber, said fountain protrusion having at least one exit port that is supported in said second portion of said fluid chamber, wherein said fountain protrusion is visible through said at least one transparent section; and
a pump having an intake port that communicates with said first portion of said fluid chamber and an output port that is coupled to said at least one exit port in said fountain protrusion, wherein said pump draws said first fluid from said first portion of said fluid chamber and pumps said first fluid into said second portion of said chamber when activated.

2. The device according to claim 1, further including an activation switch for selectively activating said pump.

3. The device according to claim 1, wherein said activation switch activates said pump for only a predetermined period of time.

4. The device according to claim 1, further including a base for supporting said fluid chamber, wherein said pump is disposed within said base.

5. The device according to claim 1, wherein said fountain protrusion has multiple exit ports disposed thereon.

6. The device according to claim 1, wherein said first fluid and said second fluid are mutually insoluble and are varied in color.

7. The device according to claim 1, wherein said fluid chamber is spherically shaped.

8. A method of creating a fluid display, comprising:
providing a fluid chamber having at least one transparent section;
filling said fluid chamber with two fluids of different weights, wherein a heavy fluid fills said fluid chamber to a first level and wherein a light fluid fills said fluid chamber from said first level to a second level;
providing a fountain structure within said fluid chamber; and
pumping said heavy fluid from a first point below said first level, through said fountain structure, to at least one second point above said first level, wherein said heavy fluid is expelled from said fountain structure.

9. The method according to claim 8, further including the step of providing an activation switch for selectively activating a pump for pumping said heavy fluid.

10. The method according to claim 9, further including the step of activating said pump only for a predetermined period of time when said activation switch is depressed.

11. The method according to claim 8, further including the step of providing a base to support said fluid chamber, wherein said pump is disposed within said base.

12. The method according to claim 8, wherein said fountain structure has multiple exit ports disposed thereon.

13. The method according to claim 8, wherein said heavy fluid and said light fluid are mutually insoluble and are varied in color.

14. The method according to claim 8, wherein said step of providing a fluid chamber includes providing a fluid chamber that is spherically shaped.
